(19) United States
(12) Patent Application Publication
(10) Pub. No.: US 2015/0239410 A1
(43) Pub. Date: Aug. 27, 2015

(54) Electrical Bypass Circuit

(71) Applicant: Perkins Engines Company Limited, Peterborough (GB)

(72) Inventors: Alistair Farman, Peterborough (GB); James Baker, Peterborough (GB); Gregory Epplin, Apex, NC (US); David Jeremiah Benedict, Apex, NC (US)

(73) Assignee: PERKINS ENGINES COMPANY LIMITED, Peterborough (GB)

(21) Appl. No.: 14/628,673

(22) Filed: Feb. 23, 2015

(30) Foreign Application Priority Data
Feb. 24, 2014 (GB) 1403182.7

(51) Int. Cl. B60R 16/03

(52) U.S. Cl. CPC B60R 16/03

(57) ABSTRACT

In a machine including an engine having one or more machine functional units powered by an electrical power source 10, an isolator configured to isolate the machine functional unit(s) and a control module from the electrical power source when an operator opens the isolator, there is provided an electrical bypass circuit that may form an electrical connection to couple the electrical power source with the control module and the machine functional unit and bypass the isolator during machine shutdown.

### CROSS-REFERENCE TO RELATED APPLICATIONS

This patent application claims the benefit of United Kingdom Patent Application No. 1403182.7, filed Feb. 24, 2014, which is incorporated by reference.

### TECHNICAL FIELD

The present disclosure relates to an electrical bypass circuit and to a machine electrical system comprising an electrical bypass circuit.

### BACKGROUND

Machines with an internal combustion engine sometimes have systems that need to go through a shutdown procedure at engine shutdown as part of their normal process. For example, a machine may have a diesel engine with an associated exhaust aftertreatment system, such as a selective catalytic reduction (SCR) system, and diesel exhaust fluid (DEF) system comprising a DEF injector to inject DEF into the exhaust aftertreatment system. The DEF system may need to go through a cooldown and purge procedure at engine shutdown.

When the engine is ‘keyed-off’ by an operator, an aftertreatment control unit may determine whether or not the DEF system needs to go through the cooldown and purge procedure. It may be determined, for example, that cooldown is required if the engine and/or exhaust temperature has exceeded a threshold value. As part of the cooldown procedure, the DEF system may continue to pump DEF around the DEF system fluid circuit using an electric DEF pump in order to cool the DEF injector and/or DEF system. When the DEF injector and/or DEF system has cooled down sufficiently, the electric pump may be run in a reverse direction to purge the DEF from the DEF system (for example to evacuate a return line and pressure line) and return the DEF to a DEF tank. Even when a cooldown procedure is not required, a purge procedure may still take place in order to remove any excess DEF from the DEF system.

The electric pump(s) utilised in a cooldown and purge procedure may be powered by a battery on the machine. After the engine has been ‘keyed-off’, the operator may isolate the battery, for example by opening an isolator switch, to prevent the battery from going flat and/or as a theft prevention technique. However, if the battery is isolated before completion of a cooldown and purge process, the pump(s) may lose power and the cooldown and purge process may fail before completion.

In some machines, the DEF system is connected to the battery in such a way that the battery cannot be isolated from the DEF system so that a cooldown and purge process cannot fail due to battery isolation. However, this can cause the battery to drain over time and can lead to dissatisfaction for operators who wish to isolate the battery entirely.

In some other machine electrical systems, in order to increase the chances of the DEF system shutting down properly, a shutdown of the engine is delayed at operator key-off, wherein the engine continues to run after key-off and automatically self-stops after a period of time. However, a delayed shutdown after key-off can be time consuming and dissatisfying for the operator and is sometimes unpopular with machine manufacturers and operators alike.

### SUMMARY OF THE DISCLOSURE

The present disclosure provides an electrical bypass circuit for use in a machine electrical system comprising an electrical power source; a control module powered by the electrical power source; a machine functional unit powered by the electrical power source and controlled by the control module; and an isolator configured to isolate the electrical power source from the control module and the machine functional unit when the isolator is in an open position based on an operational state of the electrical bypass circuit, the electrical bypass circuit comprising: a bypass switch that is operable in a first state and a second state, the electrical bypass circuit being connectable in the machine electrical system, wherein: when the bypass switch is in the first state, the electrical bypass circuit forms an electrical connection to couple the electrical power source with the control module and the machine functional unit, the electrical connection being formed independently from a circuit path of the machine electrical system that includes the isolator so that the electrical connection bypasses the isolator; and when the bypass switch is in the second state, the electrical connection of the electrical power source with the control module and the machine functional unit is decoupled so that said isolation of the electrical power source from the control module and machine functional unit is controlled by the isolator.

### BRIEF DESCRIPTION OF THE DRAWINGS

An electrical bypass circuit and machine electrical system in accordance with an aspect of the present disclosure is described, by way of example only, with reference to the following figures, in which:

FIG. 1 shows an example machine electrical system 1 comprising a battery 10, a control module 20, an isolator 30, a diesel exhaust fluid (DEF) functional unit 90 and an electrical bypass circuit 50.

FIG. 2 shows a further example machine electrical system 1 comprising a battery 10, a control module 20, an isolator 30, a DEF functional unit 90 and an electrical bypass circuit 50.

FIG. 3 shows an example method of controlling the operation of a DEF system using the machine electrical system 1 of FIG. 1 or FIG. 2.

FIG. 4 shows a machine comprising the machine electrical system 1 of FIG. 1 or FIG. 2.

### DETAILED DESCRIPTION

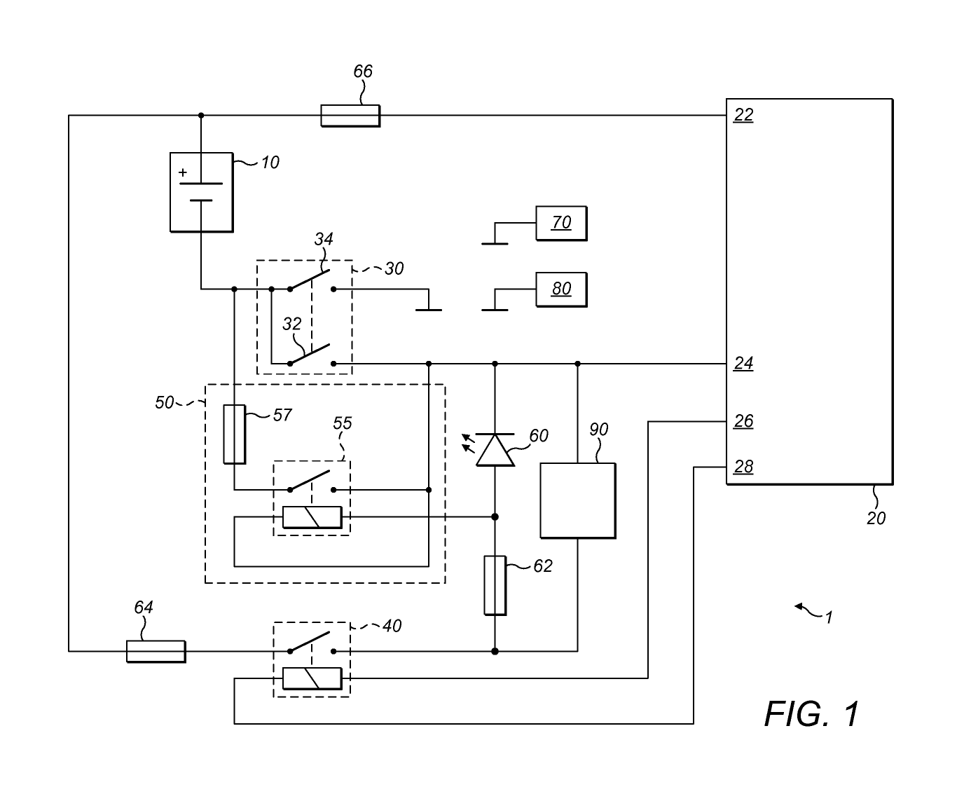

FIG. 1 shows an example representation of a machine electrical system 1 that may be part of a machine. The machine may be any type of machine, for example a transportation vehicle, such as a car, truck, van etc, a heavy equipment vehicle, for example a backhoe loader, bulldozer, tractor, etc, a water irrigator, an electricity generator etc. The machine may comprise an engine, especially an internal combustion engine, such as a diesel engine.

The machine electrical system 1 may have a battery 10 that is used to power a control module 20 via an electrical supply pin 22 and an electrical return pin 24 of the control module 20. The machine electrical system 1 may also have a diesel exhaust fluid (DEF) functional unit power relay 40 for controlling the operation of a diesel exhaust fluid (DEF) functional unit 90. The DEF functional unit 90 may be used, for example, to inject DEF into an exhaust aftertreatment system, such as a selective catalytic reduction (SCR) system, on the machine during machine operation and carry out a DEF system cooldown and purge process during engine shutdown.

In order to turn on the DEF functional unit 90, a ‘high’ control signal may be sent from control pin 26 of the control module 20, through the coil of the DEF functional unit power relay 40 and back to return pin 28 of the control module 20, such that the coil is energised by the control module 20 and the relay switch closed, thus powering the DEF system. Whilst the DEF system is powered, it may carry out DEF injection processes and/or a cooldown and purge, or purge only, process. In order to turn off the DEF functional unit 90, the control signal may be set to ‘low’, for example OV, such that the coil is de-energised and the relay switch opened.

The machine electrical system 1 also has an isolator 30. In the example shown in FIG. 1, the isolator 30 comprises a double throw switch with a first switch 32 and a second switch 34 that may open and close in unison. The double throw switch may be configured such that when it is opened, the first switch 32 may open to isolate the control module 20 and the DEF functional unit 90 from the battery 10, and the second switch 34 may open to isolate other machine electrical functional units, for example an engine starter motor and alternator 70 and a machine cab 80, from the battery 10. An operator of the machine may open the isolator 30 after engine key-off in order to prevent the battery 10 from going flat and/or as a theft prevention technique.

An electrical bypass circuit 50 may be connected in parallel across the isolator 30. The electrical bypass circuit 50 may comprise a bypass relay 55 and a bypass fuse 57. The electrical bypass circuit 50 may be configured such that when the isolator 30 is closed and the DEF functional unit power relay 40 is turned on such that current is flowing through the switch of the DEF functional unit power relay 40, the coil of the bypass relay 55 is energised by the current that flows through the switch of the DEF functional unit power relay 40. The energised coil of the isolator relay may close the switch of the isolator relay such that the operational state of the switch is a first state. In the first state, the electrical bypass circuit 50 forms an electrical connection to couple the battery 10 with the control module 20 and the DEF functional unit 90, wherein the electrical connection is formed independently from a circuit path of the machine electrical system 1 that includes the isolator 30 so as to bypass the isolator 30. Thus, a current path through the switch of the bypass relay 55 bypasses the isolator 30. If the isolator 30 is subsequently opened by an operator, either during engine operation or after engine key-off, the control module 20 and the DEF functional unit 90 will remain connected to the battery 10 by virtue of the electrical bypass circuit 50. Thus, electrical power may be maintained to the control module 20 and the DEF functional unit 90 after the isolator 30 has been opened.

If the control module 20 subsequently determines to turn off the DEF functional unit 90, for example at the end of a cooldown and purge process, it may de-energise the coil of the DEF functional unit power relay 40, which may open the switch of the DEF functional unit power relay 40 and turn off the DEF functional unit 90, as explained above. This in turn may cause the coil of the bypass relay 55 to de-energise and the switch of the bypass relay 55 to open such that the operational state of the switch is a second state. With the switch in the second state, the current path of the electrical bypass circuit 50 is broken and the electrical bypass circuit 50 no longer provides an electrical bypass around the isolator 30. If the isolator 30 is opened, the control module 20 and the DEF functional unit power relay 40 will be isolated from the battery 10 and lose electrical power.

If the control module 20 does not have electrical power, it may not operate until it regains electrical power and is operational again, for example after the isolator 30 has been closed and an engine key-on signal has been received by the control module 20. Whilst the control module 20 is non-operational, it may not attempt to change the state of the bypass switch or control any machine operations, for example controlling the DEF functional unit 90 or any other machine systems such as the engine starter motor and alternator 70 or machine cab 80.

The machine electrical system 1 may also comprise a DEF functional unit lamp 60 that turns on when the DEF functional unit is operational in order to indicate to an operator that the DEF system is operational, even if the machine engine is off and the isolator 30 is open. The machine electrical system 1 may also comprise a first DEF fuse 62, a second DEF fuse 64 and a control module fuse 66.

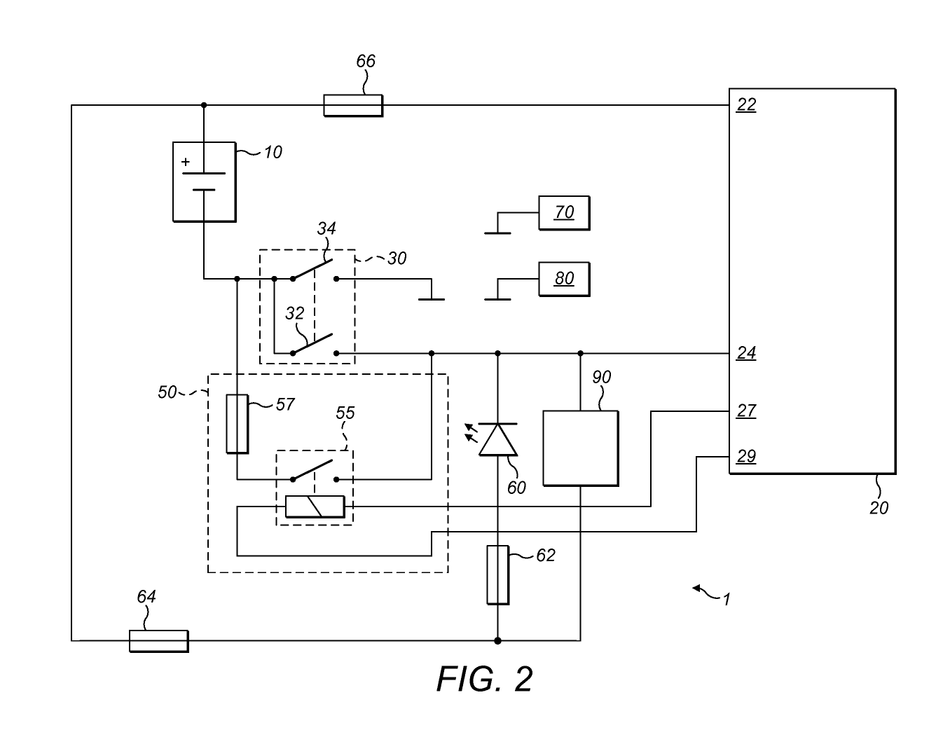

FIG. 2 shows a further example of a machine electrical system 1. The machine electrical system 1 shown in FIG. 2 is similar to that shown in FIG. 1, but does not have a DEF functional unit power relay 40. Instead, the DEF functional unit 90 may be powered by the battery 10 when the isolator 30 is in a closed position and/or the switch of the bypass relay 55 is in the first state, without any control input from the control module 20.

The state of the switch of the bypass relay 55 may be configured to be controlled by the control module 20, such that when it is determined that the DEF functional unit 90 should be operational, for example to carry out a cooldown and purge process, or just a purge process, the control module 20 may send a ‘high’ control signal from control pin 27 of the control module 20, through the coil of the bypass relay 55 and back to return pin 29 of the control module 20. Thus, the coil may be energised by the control module 20 and the bypass switch closed to the first state. When it is determined that the DEF functional unit 90 may be turned off, for example upon completion of a cooldown and purge process, or just a purge process, the control module 20 may set the control signal to low′ (for example, OV), thus de-energising the coil of the bypass relay 55, which may open the bypass switch to the second state. Thus, the state of the bypass switch may be controlled by the control module 20.

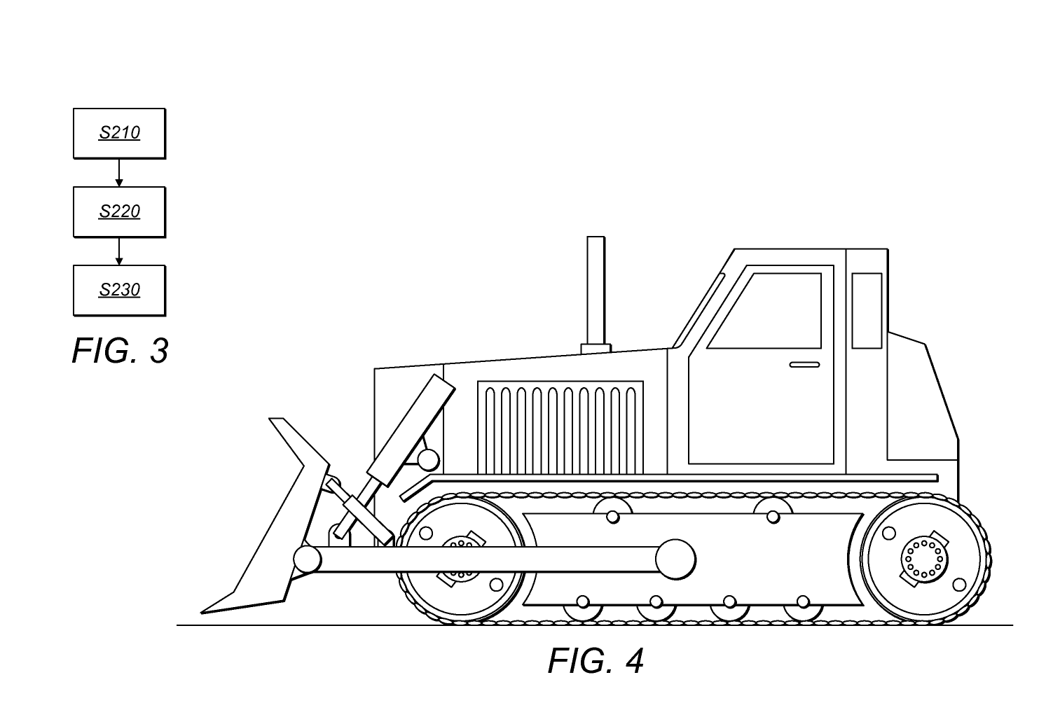

FIG. 3 shows an example of the steps that may be taken during shutdown of the machine engine.

In Step S210, a ‘key-off’ signal is received by the control module 20. Before the ‘key-off’ signal is received, the DEF functional unit 90 may already be turned on, for example in order to inject DEF into an exhaust gas aftertreatment system. After the ‘key-off’ signal is received, the DEF functional unit 90 may indicate to the control module 20 whether a cooldown and purge process is required, or if a purge only process is required. The DEF functional unit 90 may make this determination, for example, by checking the temperature of the exhaust gas aftertreatment system, wherein if the temperature exceeds a threshold temperature, for example 200° C. or 250° C., a cooldown and purge process is required, and if the temperature is less than the threshold temperature, a purge only process is required.

In Step S220, control module 20 may ensure that power is maintained to the DEF functional unit 90. In the arrangement shown in FIG. 1, power may be maintained to the DEF functional unit 90 by maintaining the ‘on’ signal to the coil of the DEF functional unit power relay 40, which in turn may result in the bypass relay switch being in the first state. In the arrangement shown in FIG. 2, power may be maintained to the DEF functional unit 90 by the control module 20 energising the coil of the bypass relay 55 such that the switch of the bypass relay 55 is in the first state (as explained above).

As also explained above, when the switch of the bypass relay 55 is in the first state, an electrical connection to couple the battery 10 with the control module 20 and the DEF functional unit 90 is formed independently from a circuit path of the machine electrical system 1 that includes the isolator 30. The isolator 30 is thereby bypassed by the electrical bypass circuit 50 such that the isolator 30 cannot isolate the DEF functional unit 90 or the control module 20 from the battery 10 even if the operator opens the isolator 30.

In Step S230, the DEF functional unit 90 may determine that the cooldown and purge process, or the purge only process, is complete and notify the control module 20 accordingly. In the arrangement shown in FIG. 1, the control module 20 may then turn off the DEF functional unit 90 by de-energising the coil of the DEF functional unit power relay 40 as described above. This may cause the switch of the DEF functional unit power relay 40 to open, thereby turning off the DEF functional unit 90 and also causing the switch of the bypass relay 55 to open, also as described above. Consequently, the switch of bypass relay 55 will be in its second state such that the electrical connection that couples the battery 10 with the control module 20 and the DEF functional unit 90 is broken and the electrical bypass circuit 50 no longer provides an electrical bypass of the isolator 30. In the arrangement shown in FIG. 2, the control module 20 may de-energise the coil of the bypass relay 55 such that the switch of the bypass relay 55 is set to the second state, thereby breaking the electrical connection that couples the battery 10 with the control module 20 and the DEF functional unit 90 so that the electrical bypass circuit 50 no longer provides an electrical bypass of the isolator 30.

Thus, if the isolator 30 is closed at the time that the bypass switch transitions from the first state to the second state, the control module 20 (and the DEF functional unit 90 in FIG. 2) will still be connected to the battery 10 and therefore be powered by the battery 10. If the isolator 30 is open at the time that the bypass switch transitions from the first state to the second state, or is opened subsequent to the bypass switch transitioning from the first state to the second state, the control module 20 (and the DEF functional unit 90 in FIG. 2) will be isolated from the battery 10 and will therefore receive no electrical power form the battery 10.

If the control module 20 is not powered by the battery 10, it may be non-operational and no longer perform any functions to try to turn on the DEF functional unit 90, or any other machine functional units, until it is operational again, as explained above. Therefore, if the bypass switch is in the second state and the isolator 30 is opened, the control module 20 may remain isolated until the control module 20 is operational again, for example after the isolator 30 is closed and an engine ‘key-on’ signal is received by the control module 20.

FIG. 4 shows an example machine 3 in which the machine electrical systems 1 described above may be implemented.

The skilled person will readily appreciate that a number of alternatives to the aspects of the disclosure described above may be used.

For example, in the above disclosure, the electrical bypass circuit 50 has a bypass relay 55 that is used to complete or break an electrical bypass of the isolator 30. However, it will be appreciated that the bypass circuit may have a bypass switch that is any form of switching device that can transition between the first switch state and the second switch state described above (for example by completing the electrical bypass circuit by forming a current path through the electrical bypass circuit 50 or breaking the electrical bypass circuit 50 by interrupting or diverting the current path through the electrical bypass circuit 50). For example, rather than using a bypass relay 55, the bypass switch may be one or more of a transistor, such as a BJT or FET, an opto-isolator etc.

Rather than using just one switch in the electrical bypass circuit 50, more than one bypass switch, each of which being the same or different type of switch, may be provided in the electrical bypass circuit 50 in order to provide the electrical bypass circuit 50 switching functionality described above. For example, the bypass relay 55 may be replaced by two or more transistors in order to carry out the functions of the bypass relay 55 described above.

Furthermore, the bypass switch state does not have to be configured to be controlled by a current passing through the switch of the DEF functional unit power relay 40 or by the control module 20. For example, the bypass switch state may be directly controlled by any other element or means, such that when the DEF functional unit 90 is active, the bypass switch is put in its first state and when the DEF functional unit 90 no longer needs to be active, the bypass switch is put in its second state. Furthermore, in the arrangement of FIG. 1, the bypass switch may be configured such that rather than the DEF functional unit 90 controlling the bypass switch state, the state may be directly controlled by the control module 20, or any other element or means.

In the above disclosure, the first state of the bypass switch corresponds to the switch of the bypass relay 55 being closed and the second state of the bypass switch corresponds to the switch of the bypass relay 55 being open. However, the electrical bypass circuit 50 could be configured such that the first state of the bypass switch corresponds to the switch of the bypass relay 55 being open and the second state of the bypass switch corresponds to the switch of the bypass relay 55 being closed. The first state could correspond to either an open or closed switch position, provided the bypass circuit bypasses the isolator 30 such that the control module 20 and DEF functional unit 90 cannot be isolated from the battery 10 by the isolator 30 when the bypass switch is in its first state. Likewise, the second state could correspond to either an open or closed switch position, provided the electrical bypass circuit 50 does not bypass the isolator 30 such that the control module 20 and DEF functional unit 90 can be isolated from the battery 10 by the isolator 30 when the bypass switch is in its second state.

Furthermore, in the arrangement shown in FIG. 1, rather than using a DEF functional unit power relay 40 to turn the DEF functional unit 90 on and off, any control means may be utilised. For example, any switch may be used instead of the DEF functional unit power relay 40, for example one or more of a transistor, such as a BJT or FET, an opto-isolator etc may be used.

In the above disclosure, maintaining power to a DEF functional unit 90 after the battery 10 has been isolated so that a cooldown and purge process may be completed is described. However, it will be appreciated that in addition, or as an alternative to, maintaining power to a DEF functional unit 90, the machine electrical system 1 may be used in respect of any other machine functional unit. For example, it may be necessary for a fan to carry out engine cooling after engine shutdown. In this case, the machine electrical system 1 may be used in respect of the fan, either in addition to the DEF functional unit 90 or as an alternative to the DEF functional unit 90, such that even if the isolator 30 is opened, the fan may continue to operate until the control module 20 decides that the fan can be turned off.

In the above disclosure, the isolator 30 has a double throw switch such that the DEF functional unit 90 and control module 20 are isolated separately from other machine functional units, for example the engine starter motor and alternator 70 and the machine cab 80. However, any isolation system may alternatively be used in the isolator 30, for example a single switch may be used instead of the double throw switch, in which case all machine functional units may be isolated by the same isolator switch. Alternatively, a treble throw switch may be used, or any number of throw switches. Furthermore, the switch(es) in the isolator 30 may be any form of switching device(s) than can complete, break or divert a current path, for example a transistor, such as a BJT or FET, an opto-isolator, a pull switch, a push switch etc.

In the above disclosure, electrical power is provided in the machine electrical system 1 from a battery 10. However, any electrical power source may be used, for example an electrical generator, such as an alternator or turbine generator, a photovoltaic cell, mains power etc.

Furthermore, it will be appreciated that the control module 20 may be any unit capable of controlling the operation of the DEF functional unit 90, or any other machine functional unit, as described above. For example, the control module 20 may be an engine control module (ECM). Furthermore, whilst it is described above that the DEF functional unit 90 determines whether or not a control and purge process, or a purge only process, should be carried out as part of an engine shutdown process, this may alternatively be determined by any one or more other control modules. For example, the control module 20 may make this determination itself, or an aftertreatment control unit (ACU) (which may or may not form part of the DEF functional unit 90) may make this determination and notify the control module 20 accordingly so that the control module 20 may exercise the proper control over DEF functional unit 90 operation.

Whilst in the machine electrical system 1 shown in FIG. 1 a DEF functional unit lamp 60 is provided, it will be appreciated that the DEF functional unit lamp 60 may be omitted from the machine electrical system 1 altogether and the operator not notified that the DEF functional unit 90 is operational. Alternatively, any other indicator may be used to indicate operation of the DEF functional unit 90 in addition, or as an alternative, to the DEF functional unit lamp 60. For example, one or more visual indication devices, such as a display screen and/or one or more audible indication devices, such as a siren or buzzer, and/or a sensor or indicator for electronic/computer reading, may be used. Furthermore, the DEF functional unit lamp 60 may form part of the electrical bypass circuit 50, or may be outside of the electrical bypass circuit 50 (as shown in FIG. 1).

Furthermore, whilst the machine electrical system 1 shown in FIG. 1 has a number of fuses 57, 62, 64 and 66, it will be appreciated that any number of these fuses may be omitted from the machine electrical system 1 and/or one or more additional fuses may be included in the machine electrical system 1.

Furthermore, whilst the electrical bypass circuit 50 is described above as being part of the particular machine electrical system 1 shown in FIG. 1, it will be appreciated that the electrical bypass circuit 50 may be fitted to any suitable machine electrical system in order to perform the functions described above. For example, it may be retrofitted into a machine electrical system comprising an electrical power source (for example, a battery), a control module, a machine functional unit (for example a DEF functional unit) and an isolator in order to provide a bypass of the isolator when the machine functional unit is operating to enable the maintenance of electrical power to the machine functional unit and control module after the isolator has been opened.

The machine electrical system 1 is not limited only to those components shown in FIG. 1, but may comprise any number of additional, or alternative elements, for example a NOx sensor, an electrical surge protector, etc.

### INDUSTRIAL APPLICABILITY

The electrical bypass circuit 50 and machine electrical system 1 described above may be implemented in a machine, for example a heavy equipment vehicle, such as a backhoe loader, which may comprise an internal combustion engine, such as a diesel engine.

The electrical bypass circuit 50 comprises a bypass switch that enables an electrical connection to couple the electrical power source 10 (for example a battery) with the control module and the machine functional unit (such as a DEF functional unit), the electrical connection being formed independently from a circuit path of the machine electrical system 1 that includes the isolator 30 so as to bypass the isolator 30. Consequently, if an operator opens the isolator 30 to isolate the electrical power source 10 while the machine functional unit 90 is operating (either before or after engine shutdown), the control module 20 and machine functional unit 90 may maintain their connection to the electrical power source 10, allowing the machine functional unit 90 to complete its operation. For example, if the machine functional unit 90 is a DEF functional unit, it may complete a cooldown and purge, or a purge only, process after engine shutdown without interruption caused by the isolator 30 being opened.

Furthermore, because the control module 20 maintains its connection to the electrical power source 10, it may turn off the machine functional unit 90, or allow it to be turned off by the isolator 30, when the machine functional unit 90 completes its operation, at which time the state of the bypass switch may be changed and the electrical bypass circuit 50 may no longer provide an electrical bypass of the isolator 30. The control module 20 and machine functional unit 90 may then be isolated from the electrical power source 10 by an open isolator 30, for example to prevent draining the electrical power source 10 and/or as a theft prevention technique.

The state of the bypass switch in the electrical bypass circuit 50 may be controllable by the machine functional unit 90. For example, as shown in FIG. 1, the machine functional unit 90 may be operable to switch the bypass relay 55 so that the bypass switch is in a first state when the machine functional unit 090 is in operation and to switch the relay so that the bypass switch is in the second state when the machine functional unit is not in operation. Thus, the switch of bypass relay 55 may change state as soon as the machine functional unit 90 is turned on or off by the machine functional unit power relay 40 by driving the coil of the bypass relay 55 using the machine functional unit power, such that when the machine functional unit 90 is operating and drawing current, the coil of the bypass relay 55 is energised, and when the machine functional unit 90 is not operating and not drawing current, the coil of the bypass relay 55 is de-energised. This may simplify operation of the machine electrical system 1 because additional control signals may not be required to operate the bypass relay 55 in the bypass circuit.

The electrical bypass circuit 50 and/or a different part of the machine electrical system 1 may comprise an indicator (such as a lamp) configured to indicate to an operator when the machine functional unit 90 is running. In this way, an operator may be notified that the machine functional unit is still running, even after the machine engine has shut down and the isolator 30 been opened, so that they may avoid conducting any maintenance until the machine functional unit 90 has stopped running. This may improve operator safety.

The isolator 30 in the machine electrical system 1 may comprise a double throw switch, with a first switch configured to isolate the electrical power source 10 from the control module 20 and the machine functional unit 90 when the double throw switch is in an open position and a second switch configured to isolate the electrical power source 10 from a further machine functional unit (for example an alternator and/or machine cab and/or start motor etc) when the double throw switch is in an open position. The electrical bypass circuit 50 may be configured such that when the electrical bypass circuit 50 is in the first state, the electrical bypass circuit 50 bypasses only the first switch. In this way, the electrical bypass circuit 50 may be able to maintain electrical power to the control module 20 and machine functional unit 90 when the isolator 30 is open, but still allow the isolator 30 to isolate other machine functional units when the isolator 30 is open. Consequently, opening the isolator 30 may have the effect of immediately isolating a number of machine functional units from the electrical power source 10, with the electrical bypass circuit 50 still providing a bypass of the isolator 30 for the control module 20 and a particular machine functional unit 90. Thus, safety of the system and drainage of the electrical power source 10 may be improved by isolating a number of machine functional units quickly whilst still enabling other machine functional units to maintain power to complete their operations.

1. An electrical bypass circuit for use in a machine electrical system comprising an electrical power source; a control module powered by the electrical power source; a machine functional unit powered by the electrical power source and controlled by the control module; and an isolator configured to isolate the electrical power source from the control module and the machine functional unit when the isolator is in an open position based on an operational state of the electrical bypass circuit, the electrical bypass circuit comprising:
a bypass switch that is operable in a first state and a second state, the electrical bypass circuit being connectable in the machine electrical system, wherein:
when the bypass switch is in the first state, the electrical bypass circuit forms an electrical connection to couple the electrical power source with the control module and the machine functional unit, the electrical connection being formed independently from a circuit path of the machine electrical system that includes the isolator so that the electrical connection bypasses the isolator; and
when the bypass switch is in the second state, the electrical connection of the electrical power source with the control module and the machine functional unit is decoupled so that said isolation of the electrical power source from the control module and machine functional unit is controlled by the isolator.

2. The electrical bypass circuit of claim 1 being configured such that the bypass switch is in the first state when the machine functional unit is operating and in the second state when the machine functional unit is not operating.

3. The electrical bypass circuit of claim 1 being further configured such that when the isolator is in an open position and the bypass switch is in the second state, the state of the bypass switch cannot be changed and the control module cannot operate the machine functional unit.

4. The electrical bypass circuit of claim 1, wherein the state of the bypass switch is controllable by the machine functional unit.

5. The electrical bypass circuit of claim 4, wherein the bypass switch comprises a relay, wherein the machine functional unit is operable to switch the relay so that the bypass switch is in a first state when the machine functional unit is in operation and to switch the relay so that the bypass switch is in the second state when the machine functional unit is not in operation.

6. The electrical bypass circuit of claim 1, wherein the machine functional unit is a diesel exhaust fluid functional unit.

7. The electrical bypass circuit of claim 6, wherein the diesel exhaust fluid functional unit is configured for performing a diesel exhaust fluid cooldown and purge procedure

8. The electrical bypass circuit of claim 1, comprising an indicator configured to output a signal to indicate when the machine functional unit is operating.

9. A machine electrical system for use in a machine comprising an internal combustion engine, the machine electrical system comprising:
an electrical power source;
a control module powered by the electrical power source;
a machine functional unit powered by the electrical power source and controlled by the control module;
an isolator configured to isolate the electrical power source from the control module and the machine functional unit when the isolator is in an open position based on an operational state of the electrical bypass circuit; and
the electrical bypass circuit of any preceding claim, wherein:
when the bypass switch is in the first state, the electrical bypass circuit forms an electrical connection to couple the electrical power source with the control module and the machine functional unit, the electrical connection being formed independently from a circuit path of the machine electrical system that includes the isolator so that the electrical connection bypasses the isolator; and
when the bypass switch is in the second state, the electrical connection of the electrical power source with the control module and the machine functional unit is decoupled so that said isolation of the electrical power source from the control module and the machine functional unit is controlled by the isolator.

10. The machine electrical system of claim 9, wherein the isolator comprises a double throw switch comprising a first switch and a second switch; and wherein
the first switch is configured to isolate the electrical power source from the control module and the machine functional unit when the double throw switch is in an open position;
the second switch is configured to isolate the electrical power source from a further machine functional unit when the double throw switch is in an open position based on an operational state of the electrical bypass circuit; and
the electrical bypass circuit is configured such that when the bypass switch is in the first state, the electrical bypass circuit bypasses only the first switch.

11. The machine electrical system of claim 9, further comprising an indicator configured to indicate operation of the machine functional unit to an operator of the machine when the machine functional unit is operating.

12. The machine electrical system of claim 9, wherein the machine functional unit is a diesel exhaust fluid functional unit.

13. The machine electrical system of claim 12, wherein the diesel exhaust fluid functional unit is configured for performing a cooldown and purge procedure.

14. A machine comprising the machine electrical system of claim 9.

15. The electrical bypass circuit of claim 2 being further configured such that when the isolator is in an open position and the bypass switch is in the second state, the state of the bypass switch cannot be changed and the control module cannot operate the machine functional unit.

16. The electrical bypass circuit of claim 2, wherein the state of the bypass switch is controllable by the machine functional unit.

17. The electrical bypass circuit of claim 16, wherein the bypass switch comprises a relay, wherein the machine functional unit is operable to switch the relay so that the bypass switch is in a first state when the machine functional unit is in operation and to switch the relay so that the bypass switch is in the second state when the machine functional unit is not in operation.

18. The machine electrical system of claim 10, further comprising an indicator configured to indicate operation of the machine functional unit to an operator of the machine when the machine functional unit is operating.

19. The machine electrical system of claim 10, wherein the machine functional unit is a diesel exhaust fluid functional unit.

20. The machine electrical system of claim 19, wherein the diesel exhaust fluid functional unit is configured for performing a cooldown and purge procedure.
